(19) United States
(12) Patent Application Publication
(10) Pub. No.: US 2004/0040833 A1
(43) Pub. Date: Mar. 4, 2004

(54) Apparatus and method for plasma treating an article

(75) Inventors: Marc Schaepkens, Ballston Lake, NY (US); Charles Dominic Iacovangelo, Clifton Park, NY (US); James Neil Johnson, Niskayuna, NY (US); William Arthur Morrison, Albany, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company, Niskayuna, NY (US)

(21) Appl. No.: 10/064,888

(22) Filed: Aug. 27, 2002

(51) Int. Cl. B01J 19/08

(52) U.S. Cl. 204/164; 422/186.04

(57) ABSTRACT

An apparatus that generates at least one plasma that is stable and adjustable in real time. In one embodiment, the apparatus includes multiple plasma sources that can either be “tuned” in real time to generate plasmas that are similar to each other or, conversely, “detuned” to generate dissimilar plasmas. The apparatus may be sued to provide plasma treatment—such as, but not limited to, coating, etching and activation for an article. The invention also provides a plasma source in which operating parameters are adjustable in real time. Methods of providing such plasmas and treating an article using such plasmas are also disclosed.

### BACKGROUND OF INVENTION

The invention relates to an apparatus for generating a substantially uniform plasma. More particularly, the invention relates to an apparatus for generating a substantially uniform plasma for treating an article. Even more particularly, the invention relates to an apparatus that is capable of generating a controllable, adjustable plasma for treating an article.

Plasma sources are used to provide a variety of surface treatments for a number of articles. Examples of such surface treatments include deposition of various coatings, plasma etching, and plasma activation of the surface. The characteristics of the plasma treatment process are strongly affected by the operating parameters of the plasma source.

Individual plasma sources, such as expanding thermal plasma (also referred to hereinafter as “ETP”) sources, can be used to treat surface areas having a diameter in the range of about 10-15 cm. During plasma treatment, conditions within the plasma source may drift; e.g., cathode-to-anode distance may change over time due to erosion of the cathode, or cathode voltage or operating pressure may change. To counteract such drift, particularly changes in cathode-to-anode distance, disruption of the process and disassembly of the plasma source are usually required.

An array of multiple plasma sources may be used to coat larger substrate areas. Ideally, the individual plasmas generated by each of the plasma sources in the array should have the same characteristics. In practice, however, source-to-source variation in plasma characteristics and, consequently, in the resulting plasma treatment, is commonly observed. A significant amount of the variability is related to the previously described variations in the individual plasma sources.

Drift within a single plasma source cannot be counteracted in real time; such corrections require disruption of the process and disassembly of the plasma source. Where multiple plasma sources are used, minimization of source-to-source variation in the generated plasmas is often desirable. Therefore, what is needed is an apparatus that is capable of generating a stable, controllable plasma. What is also needed is an apparatus for plasma treating an article using a stable, controllable, adjustable plasma. What is further needed is a plasma source that generates a plasma and is adjustable so as to alter the properties of the generated plasma.

### SUMMARY OF INVENTION

The present invention meets these and other needs by providing an apparatus that generates at least one plasma that is stable and adjustable in real time. In one embodiment, the apparatus includes multiple plasma sources that can either be “tuned” in real time to generate plasmas that are similar to each other or, conversely, “detuned” to generate dissimilar plasmas. The apparatus may be used to provide plasma treatment—such as, but not limited to, coating, etching, heating, lighting or illumination, and activation—for an article. The invention also provides a plasma source in which operating parameters are adjustable in real time. Methods of providing such plasmas and treating an article using such plasmas are also disclosed.

Accordingly, one aspect of the invention is to provide an apparatus for generating a substantially controllable plasma. The apparatus comprises: at least one plasma source, the plasma source comprising a plasma chamber in which the substantially controllable plasma is generated, at least one cathode and an anode disposed in the plasma chamber, the at least one cathode and the anode being separated by a gap, the gap being adjustable, a power source coupled to the anode and the at least one cathode for providing a voltage across the anode and the at least one cathode, a plasma gas inlet for introducing a gas for generating the plasma (hereinafter referred to as a “plasma gas”) from a plasma gas source into the plasma chamber at a plasma gas flow rate, and a sensor for monitoring conditions within the plasma chamber; and a second chamber in fluid communication with the plasma chamber through an exit port, wherein the second chamber is maintained at a second pressure that is less than a first pressure in the plasma chamber, and wherein the substantially controllable plasma flows from the plasma chamber into the second chamber through the exit port.

A second aspect of the invention is to provide a plasma source for generating a substantially controllable plasma. The plasma source comprises: a plasma chamber in which the substantially controllable plasma is generated; an anode disposed at a first end of the plasma chamber, the first end having an exit port through which the substantially controllable plasma exits the plasma chamber; at least one adjustable cathode disposed in the plasma chamber, wherein the at least one adjustable cathode is movable to establish a gap between the anode and the at least one adjustable cathode; a power source coupled to the anode and the at least one adjustable cathode for providing a voltage across the anode and the at least one adjustable cathode; a plasma gas inlet for introducing a plasma gas from a plasma gas source into the plasma chamber at a plasma gas flow rate; and at least one sensor for detecting and monitoring conditions within the plasma chamber.

A third aspect of the invention is to provide an apparatus for generating a substantially controllable expanding thermal plasma. The apparatus comprises: at least one expanding thermal plasma source, the at least one expanding thermal plasma source comprising: a plasma chamber in which the substantially controllable plasma is generated; an anode; at least one adjustable cathode disposed in the plasma chamber, wherein the at least one adjustable cathode is movable to establish a gap between the anode and the at least one adjustable cathode; a power source coupled to the anode and the at least one adjustable cathode for providing a voltage across the anode and the at least one adjustable cathode; a plasma gas inlet for introducing a plasma gas from a plasma gas source into the plasma chamber at a plasma gas flow rate; and at least one sensor for detecting and monitoring conditions within the plasma chamber; and a second chamber in fluid communication with the plasma chamber through an exit port, wherein the second chamber is maintained at a second pressure that is less than a first pressure in the plasma chamber, and wherein the substantially controllable plasma flows from the plasma chamber into the second chamber through the exit port.

A fourth aspect of the invention is to provide a method for generating a substantially controllable plasma. The method comprises the steps of: providing at least one plasma source, the at least one plasma source comprising: a plasma chamber; an anode; at least one adjustable cathode disposed in the plasma chamber; a power source coupled to the anode and the at least one adjustable cathode; a plasma gas inlet; and at least one sensor; providing a plasma gas through the plasma gas inlet to the plasma chamber in each of the at least one plasma source; generating a plasma in the plasma chamber; monitoring at least one parameter within the plasma chamber; and controlling the plasma, wherein the plasma is controlled by adjusting conditions within the plasma chamber, based upon the monitoring of the at least one parameter.

A fifth aspect of the invention is to provide a method for treating an article using a substantially controllable expanding thermal plasma. The method comprises the steps of: providing at least one expanding thermal plasma source, wherein the at least one expanding thermal plasma source comprises: a plasma chamber; an anode; at least one adjustable cathode disposed in the plasma chamber; a power source coupled to the anode and the at least one adjustable cathode; a plasma gas inlet; and at least one sensor; providing a plasma gas through the plasma gas inlet to the plasma chamber in each of the at least one plasma source; generating a plasma in the plasma chamber; monitoring at least one parameter within the plasma chamber; and controlling the plasma, wherein the plasma is controlled by adjusting conditions within the plasma chamber, based upon the monitoring of the at least one parameter; forming an expanding thermal plasma by expanding the plasma through an exit port into a second chamber in fluid communication with the plasma chamber, wherein the second chamber contains the article and is maintained at a second pressure that is less than a first pressure in said plasma chamber; and impinging the expanding thermal plasma on a surface of the article, thereby treating the article.

These and other aspects, advantages, and salient features of the present invention will become apparent from the following detailed description, the accompanying drawings, and the appended claims.

### BRIEF DESCRIPTION OF DRAWINGS

FIG. 1 is a schematic representation of an apparatus for generating a substantially controllable plasma;

FIG. 2 is a plot of plasma chamber pressure as a function of cathode length, measured at a constant flow rate of argon gas into the plasma chamber;

FIG. 3 is a plot of cathode voltage as a function of cathode length, measured at a constant flow rate of argon gas into the plasma chamber;

FIG. 4 is a plot of cathode voltage and plasma chamber pressure as a function of time;

FIG. 5 is a plot of deposition profiles of silicon carbide films deposited using multiple plasma sources in both the tuned and detuned states; and

FIG. 6 is a plot of individual Taber delta haze values for an abrasive resistant silicone coating as a function of substrate location and position with respect to the individual ETP sources.

### DETAILED DESCRIPTION

In the following description, like reference characters designate like or corresponding parts throughout the several views shown in the figures. It is also understood that terms such as “top”, “bottom”, “outward”, “inward”, and the like are words of convenience and are not to be construed as limiting terms.

Referring to the drawings in general, it will be understood that the illustrations are for the purpose of describing an embodiment of the invention and are not intended to limit the invention thereto.

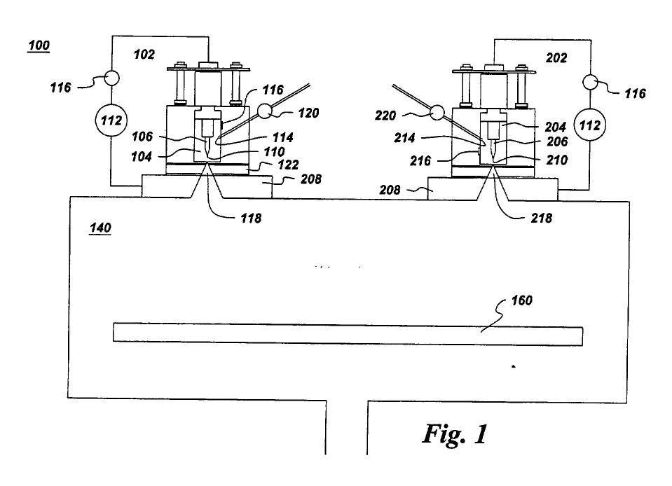

Turning now to FIG. 1, an apparatus 100 for producing a substantially controllable plasma of the present invention, comprising a first plasma source 102, a second plasma source 202, and a second chamber 140, is shown. The present invention is not limited to the embodiment represented in FIG. 1; apparatus 100 may comprise a single plasma source or more than two plasma sources as well. It is understood that, while various features of first plasma source 102 are described in detail and are referred to throughout the following description of the invention, the following description is applicable to second plasma source 202 as well.

First plasma source 102 comprises a plasma chamber 104, a cathode 106, and an anode 108. Cathode 106 is disposed within, and extends into, plasma chamber 104. While a single cathode 106 is shown in FIG. 1, it is understood that plasma source 102 may include multiple cathodes 106. Anode 108 is located at one end of plasma chamber 102. An exit port 118 provides fluid communication between plasma chamber 104 and second chamber 140. The substantially controllable plasma generated within plasma chamber 104 exits plasma chamber 104 through exit port 118 and enters second chamber 140. In one embodiment, exit port 118 may comprise an orifice formed in anode 108. In another embodiment, exit port may comprise at least one “floating” (i.e., electrically insulated from both cathode 106 and anode 108) cascade plate 122 separating anode 108 from the rest of plasma chamber 102. Alternatively, exit port 118 may be located in a floating wall in one of plasma chamber 102 and second chamber 140.

A gas for generating the plasma (hereinafter referred to as a “plasma gas”) is injected into plasma chamber 104 through at least one plasma gas inlet 114. the plasma gas may comprise at least one inert or non-reactive gas, such as, but not limited to, a noble gas (i.e., He, Ne, Ar, Xe, Kr). Alternatively, in embodiments where the plasma is used to etch the surface, the plasma gas may comprise a reactive gas, such as, but not limited to, hydrogen, nitrogen, oxygen, fluorine, or chlorine. Flow of the plasma gas may be controlled by a flow controller, such as a mass flow controller, located between a plasma gas source (not shown) and the at least one plasma gas inlet 114. A first plasma is generated within plasma chamber 104 by injecting the plasma gas into plasma chamber 104 through the at least one plasma gas inlet 114 and striking an arc between cathode 106 and anode 108. The voltage needed to strike an arc between cathode 106 and anode 108 is provided by power source 112. In one embodiment, power source 112 is an adjustable DC power source that provides up to about 100 amps of current at a voltage of up to about 50 volts. Second chamber 140 is maintained at a second chamber pressure by a vacuum system (not shown), which is substantially less than a first plasma chamber pressure. In one embodiment, second chamber 140 is maintained at a pressure of less than about 1 torr (about 133 Pa) and, preferably, at a pressure of less than about 100 millitorr (about 0.133 Pa), while plasma chamber 104 is maintained at a pressure of at least about 0.1 atmosphere (about 1.01×10⁴ Pa). As a result of the difference between the first plasma chamber pressure and the second chamber pressure, the first plasma passes through exit port 118 and expands into second chamber 140.

Second chamber 140 is adapted to contain an article 160 that is to be treated with the plasmas produced by apparatus 100. In one embodiment, such plasma treatment of article 160 comprises injecting at least one reactive gas into the plasma produced by apparatus 100 and depositing at least one coating on a surface of article 160. The surface of article 160 upon which the at least one plasma impinges may be either planar or non-planar. Apparatus 100 is capable of providing other plasma treatments in which at least one plasma impinges upon a surface of article 160, such as, but not limited to, plasma etching at least one surface of article 160, heating article 160, lighting or illuminating article 160, or functionalizing (i.e., producing reactive chemical species) a surface of article 160. The characteristics of the plasma treatment process are strongly affected by the operating parameters of the plasma source. Among such operating parameters are the operating pressure within the plasma source, plasma resistance, the potential across the cathode and anode, the plasma current, and the cathode-to-anode distance.

In one embodiment, the plasmas generated by at least one of first plasma source 102 and second plasma source 202 are expanding thermal plasmas (also referred to hereinafter as “ETP”). In an ETP, a plasma is generated by ionizing the plasma source gas in the arc generated between at least one cathode 106 and anode 108 to produce a positive ion and an electron. For example, when an argon plasma is generated, argon is ionized, forming argon ions (Ar⁺) and electrons (e⁻). The plasma is then expanded into a high volume at low pressure, thereby cooling the electrons and positive ions. In the present invention, the plasma is generated in plasma chamber 104 and expanded into second chamber 140 through exit port 118. As previously described, second chamber 140 is maintained at a substantially lower pressure than the plasma chamber 104. In an ETP, the positive ion and electron temperatures are approximately equal and in the range of about 0.1 eV (about 1000 K). In other types of plasmas, the electrons have a sufficiently high temperature to substantially affect the chemistry of the plasma. In such plasmas, the positive ions typically have a temperature of about 0.1 eV, and the electrons have a temperature of about 1 eV, or 10,000 K, or higher. Consequently, the electrons in the ETP are too cold and thus have insufficient energy to cause direct dissociation of any gases that may be introduced into the ETP. Such gases may instead undergo charge exchange and dissociative recombination reactions with the electrons within the ETP.

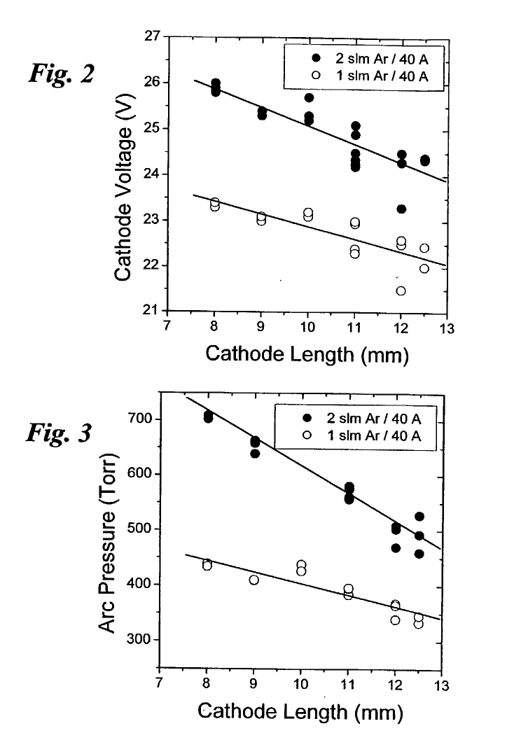

The characteristics of the plasma generated by plasma source 102 depend in part upon gap 110, which is defined herein as the spacing between cathode 106 and anode 108. FIGS. 2 and 3 are plots of plasma chamber pressure and cathode voltage as a function of cathode length, respectively. In this particular embodiment of the invention, gap 110 decreases as the cathode length increases. In each plot, the cathode-to-anode distance was systematically varied and the data was collected using a constant flow rate of argon gas into the plasma chamber. As seen in FIG. 2, the pressure of the plasma decreases with decreasing cathode-to-anode distance. Similarly, the voltage needed to sustain the plasma decreases with decreasing cathode-to-anode distance, as illustrated in FIG. 3.

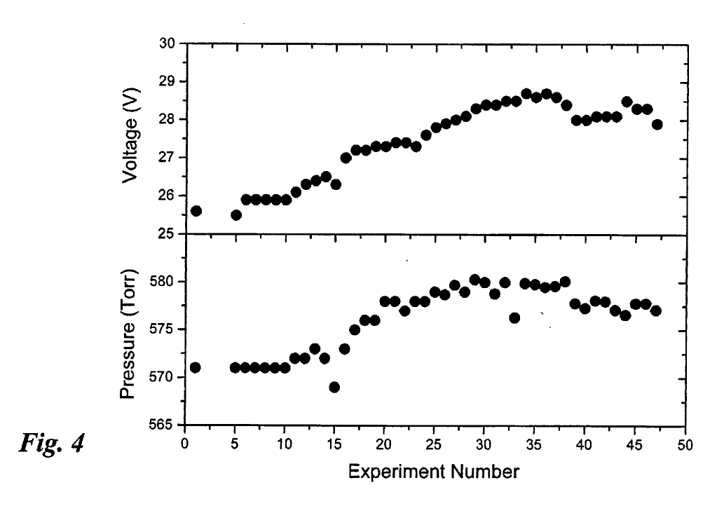

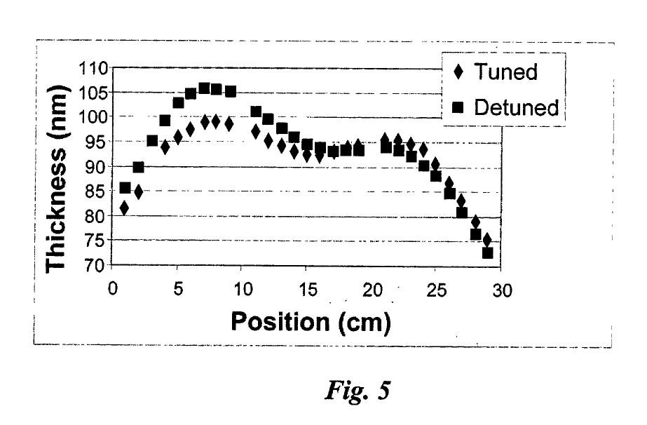

Changes—or “drift”—in cathode-to-anode may occur during operation of a plasma source. Drift may be caused by erosion of either the cathode or anode, deposition of material on either the cathode or anode, mechanical settling or seating of plasma source components, and thermal expansion of plasma source components. Variation of cathode voltage and plasma pressure as functions of time (expressed in FIG. 4 as the number of experiments run under the same conditions) are shown in FIG. 4. It is understood that some factors—such as deposition of material on either the cathode or anode—may cause drift in a direction opposite that shown in FIG. 4. As drift occurs with passing time, both the cathode voltage and plasma pressure that are needed to sustain the plasma shift (i.e., either increase or decrease) as well. These trends are consistent with those shown in FIGS. 2 and 3. Typically, cathode-to-anode distance cannot be adjusted in real time; complete disassembly of the plasma source is usually required to make the adjustment.

The present invention provides a plasma source 102 in which gap 110 (i.e., cathode-to-anode distance) is adjustable in real time to a desired distance in response to selected conditions within plasma chamber 104, such as, but not limited to, plasma pressure, cathode voltage, plasma current, and plasma gas flow rate. At least one sensor 116 monitors and detects any change in such conditions within plasma chamber 104. The sensor(s) selected for use in plasma source 102 depends upon the property to be monitored. Non-limiting examples of the at least one sensor 116 that may be used monitor conditions within plasma chamber 104 include: a pressure sensor, such as a transducer, in fluid communication with plasma chamber 104; a voltmeter (or any similar voltage measurement device) for measuring and detecting cathode voltage; and an ammeter for measuring and detecting plasma current. Any change detected by the at least one sensor 116 is fed to a controller, which then adjusts gap 110 by changing the position of one of cathode 106 and anode 108 to maintain the selected conditions within desired ranges.

In one embodiment, plasma source 102 includes at least one adjustable cathode 106. Gap 110 may be set to a predetermined distance by moving cathode 106. As seen if FIGS. 2 and 3, respectively, changes in plasma chamber pressure or cathode voltage, as detected and monitored by the at least one sensor 116, are indicative of changes in gap 110. Cathode drift may, for example, be indicated by shifts or changes in cathode voltage and plasma chamber pressure. Plasma chamber pressure data obtained during statistical process control as feedback, for example, may be used to control gap 110. Compensation of cathode drift may be achieved during operation of plasma source 102 by movement of adjustable cathode 106 in response to input by the at least one sensor 116 to maintain gap 110 at the selected distance. Variation due to cathode drift of the plasma generated by plasma source 104 is thus eliminated or significantly reduced by such adjustment of cathode 106. Such movement of the adjustable cathode 106 may be performed in real time either manually or by a controller.

In some instances, it may be desirable to vary the properties of the plasma generated by plasma source 102 over time. Non-limiting examples of situations in which plasma properties may be altered during operation include deposition of multiple layers on a single substrate or performing multiple plasma treatments of a single article. The ability to adjust gap 110 in real time permits the properties of the plasma generated by plasma source 102 to be modified in a controllable fashion without disassembly of plasma source 102.

Movement of adjustable cathode 106 may be accomplished by a pressure means coupled to the movable cathode 106. In one embodiment, pressure means include a pressure plate coupled to a rear portion of adjustable cathode 106 by either set screws or a screw drive. As conditions dictate, gap 110 may be increased or decreased by either applying or releasing pressure to the pressure plate, or gap 110 may be maintained at a constant value as adjustable cathode 106 erodes during operation of plasma source 102 by applying pressure plate as needed. In another embodiment, pressure means may comprise a pneumatic drive coupled to adjustable cathode 106. The pneumatic drive may increase, decrease, or maintain gap 110 at a selected value—as conditions dictate—by moving adjustable cathode 106 accordingly.

In another embodiment, plasma source 102 further includes a screw or worm drive for moving adjustable cathode 106, thereby adjusting gap 110. In yet another embodiment, adjustable cathode 106 comprises a wire, and movement of adjustable cathode 106 to either increase, decrease, or maintain gap 110 at a selected value is achieved by coupling a wire feed to adjustable cathode 106.

Adjustable cathode 106, in one embodiment, is movable in a direction that is normal to cascade plate 122. Here the longitudinal axis of adjustable cathode 106 is concentric with exit port 118. Alternatively, adjustable cathode 106 is movable in a direction parallel to cascade plate 122.

In one embodiment, cathode 106 is movable and anode 108 is fixed during operation of plasma source 102. In other embodiments, however, gap 110 may be adjusted by providing first plasma source 102 with a movable anode 108. Movement of anode 108 may be accomplished by mechanisms similar to those previously described for providing movement of adjustable cathode 106. First plasma source 102 may also include both a movable cathode 106 and a movable anode 108.

In those embodiments in which apparatus 100 includes more than one plasma source, second plasma source 202 includes features corresponding to those of first plasma source 102, which are described herein. For example, plasma source 202 includes cathode 206, anode 208, gap 210, at least one plasma gas inlet 214, at least one sensor 216, exit port 218, and cascade plate 222. The voltage needed to strike an arc between cathode 206 and anode 208 is provided by either power source 112 or a separate power source.

In some instances, it is desirable to treat article 160 uniformly with a plasma. The characteristics (e.g., coating thickness, degree of etching or activation) of a region treated by a single plasma source, such as an ETP source, generally exhibit a profile having a Gaussian distribution about the axis of the plasma source. When multiple plasma sources are used to treat article 160, uniformity may be promoted by positioning the individual plasma sources such that the resulting Gaussian distributions overlap. The profile, as well as the width and height of the distributions, are dependent in part upon the characteristics of the plasmas that are used to treat the substrate. The characteristics of each of the plasmas are in turn dependent upon the conditions—such as cathode voltage, plasma gas pressure and cathode-to-anode distance (gap 110)—used to generate the plasmas within the individual plasma sources.

In one embodiment, conditions within first plasma source 104—and, consequently, the first plasma produced by first plasma source 102—are adjustable with respect to conditions within plasma chamber 204 and second plasma, and vice versa. For example, first plasma source 102 and second plasma source 202 may be “tuned” to eliminate or minimize variation between the first plasma and the second plasma by setting at least one of plasma pressures, cathode voltages, and gaps 110, 210 of first plasma source 102 and second plasma source 202 to be equal to each other. Using any of the means that have been described above for adjusting movable cathodes 106, 206, gap 110 and gap 210 may then be maintained at the same value during operation by moving adjustable cathodes 106, 206 (or, in some embodiments, adjustable anodes 108, 208) in response to input from sensors 116, 216. Such tuning of first plasma source 102 and second plasma source 202 may be advantageous, for example, for depositing a coating having a substantially uniform profile of at least one selected property over a large surface area of a planar substrate.

Conversely, first plasma source 102 and second plasma source 202 may be “detuned” by moving adjustable cathodes 106, 206 to provide gaps 110, 210 of unequal size, thereby producing a first plasma and second plasma that are dissimilar with respect to each other. Detuning may be desirable, for example, for plasma treating a non-planar substrate. In such instances, the working distance (i.e., the distance between a plasma source and the substrate surface) for first plasma source 102 may differ from the working distance for second plasma source 202. At the point at which they impinge on the surface of article 160, the properties of the first plasma (generated by first plasma source 102) would consequently differ from those of the second plasma (generated by second plasma source 202). Differences in working distances for the individual plasma sources may be compensated for by moving adjustable cathodes 106, 206 (or, in some embodiments, adjustable anodes 108, 208) to provide gaps 110, 210 of unequal size to produce first and second plasmas that have essentially the same properties at their respective points of impingement upon the surface of article 160.

The characteristics of the plasma generated by first plasma source 102 also depends upon the pressure of the plasma gas within plasma chamber 104 and the voltage (or potential) of cathode 106. Thus, the characteristics of the plasma may also be controlled by adjusting at least one of the pressure of the plasma gas within plasma chamber 104 and the voltage of cathode 106. Plasma gas pressure may be monitored by the at least one sensor 116 and adjusted accordingly. One means of adjusting the plasma gas pressure is by controlling the flow of plasma gas into plasma chamber 104 through plasma gas inlet 114. Means for controlling the flow of plasma gas into plasma chamber 104 include, but are not limited to, needle valves and mass flow controllers. The cathode voltage (or potential) may be similarly monitored by the at least one sensor 116, and adjusted by adjusting power supply 112 accordingly. It is understood that, in those embodiments having a second plasma source 202, the characteristics of the plasma generated by second plasma source 202 may be similarly controlled by adjusting at least one of the plasma gas pressure within plasma chamber 204 and the voltage of cathode 206 in response to input provided by the at least one sensor 216.

In one embodiment, the present invention permits at least one of the pressure of the plasma gas within plasma chamber 104 and the cathode voltage of cathode 106 to be adjustable with respect to the plasma gas pressure within plasma chamber 204 and the cathode voltage of cathode 206, respectively. Thus, conditions within plasma chamber 104 and thus the first plasma produced by first plasma source 102—are adjustable with respect to conditions within plasma chamber 204 and the second plasma produced by second plasma source 202, and vice versa. For example, the first plasma generated by first plasma source may be either “tuned” to eliminate or minimize variation between the first plasma and the second plasma or “detuned” to be dissimilar with respect to each other.

Tuning of the first plasma and the second plasma may be achieved by adjusting at least one of plasma pressures and cathode voltages of first plasma source 102 and second plasma source 202 to be equal to each other. Conversely, the first and second plasma may be detuned by adjusting at least one of plasma pressures and cathode voltages of first plasma source 102 and second plasma source 202 to be dissimilar with respect to each other. Plasma pressures within plasma chambers 104, 204 may be monitored by the at least one sensors 116, 216, respectively. Using the means for controlling the flow of plasma gas into each of plasma chambers 104, 204 through plasma gas inlets 114, 214 described above, the plasma pressures within each of plasma chambers 104, 204 may be adjusted in response to the input provided by the at least one sensors 116, 216. Similarly, cathode voltages of cathodes 106, 206 may be monitored by the at least one sensors 116, 216, respectively, and adjusted with respect to each other by adjusting power supply 112 accordingly.

An example of such tuning and detuning of the plasmas produced by multiple plasma sources is shown in FIG. 4. The profiles of a-SiₓC_{y}:H films deposited on a substrate by injecting vinyltrimethylsilane (VTMS) into plasmas generated by multiple ETP sources are plotted as a function of lateral position on the substrate. The film profiles correspond to the properties—such as, but not limited to, temperature, density, cross-sectional area, and reactant concentration—of the plasmas that are used to deposit the films. The squares in FIG. 4 represent the film profile that is obtained when the two sources that are detuned; i.e., operated at different plasma pressures and cathode voltages. The dissimilar plasmas produce a profile in which the thickness of the deposited exhibits a significant variation. The diamonds in FIG. 4 represent the film profile that is obtained when the pressures and voltages of the two sources have been tuned to be equal. The resulting profile exhibits less variation than that obtained using detuned plasma sources.

Another aspect of the invention is to provide an article having at least one coating disposed on a surface of the article, wherein the at least one coating is deposited by the method described herein using apparatus 100. The at least one coating is substantially uniform and has a selected property that exhibits a variation of less than about 10% across the surface of the article. The selected property of the at least one coating may be one of coating thickness, abrasion resistance, ultraviolet radiation absorbance, infrared radiation reflectivity, modulus, hardness, oxygen permeability, water permeability, adhesion, surface energy, thermal conductivity, and electrical conductivity. The at least one coating may comprise an abrasion-resistant coating, an ultraviolet filtering coating, an infrared reflective coating, an oxygen- or moisture-barrier coating, an anti-reflective coating, a conductive coating, interlayers, an adhesion layer and combinations thereof. The coatings and deposition methods are described in U.S. Pat. No. 6,420,032, entitled “Adhesion Layer for Metal Oxide UV Filters” by Charles Dominic Iacovangelo et al.; U.S. Pat. No. 6,426,125, entitled “Multilayer Article and Method of Making by Arc Plasma Deposition” by Barry Lee-Mean Yang et al.; U.S. Pat. No. 6,261,694, entitled “Infrared Reflecting Coatings” by Charles Dominic lacovangelo; and U.S. Pat. No. 6,376,064, entitled “Layered Article with Improved Microcrack Resistance and Method of Making” by Steven Marc Gasworth et al., all of which are incorporated herein by reference in their entirety.

The advantages and salient features of the present invention are illustrated by the following example:

### EXAMPLE 1

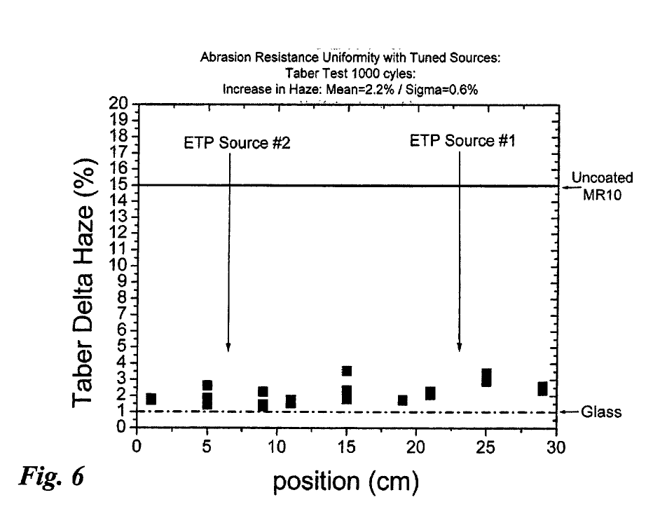

An abrasive resistant silicone (SiOₓC_{y}) coating was deposited on a polycarbonate LEXAN® substrate using an array of expanding thermal plasma (ETP) sources. Each of the ETP sources included an adjustable cathode of the present invention. The ETP plasma sources were tuned by equalizing the pressures within the respective plasma chambers. The coating was formed by injecting oxygen (O₂) and octamethyltetracyclosiloxane (D4) into each of the ETPs. The resulting coating had a thickness of about 2 microns. The abrasion resistance of the coating was determined by a 1000 cycle Taber abrasion test. A plot of the individual Taber Delta haze values as a function of substrate location and position with respect to the individual ETP sources is shown in FIG. 6. The coating exhibited a uniform 2% increase in haze with a standard deviation of 0.6% across the large area substrate.

While typical embodiments have been set forth for the purpose of illustration, the foregoing description should not be deemed to be a limitation on the scope of the invention. Accordingly, various modifications, adaptations, and alternatives may occur to one skilled in the art without departing from the spirit and scope of the present invention.

1. An apparatus for generating a substantially controllable plasma, the apparatus comprising:
a) at least one plasma source, said at least one plasma source comprising a plasma chamber in which said substantially controllable plasma is generated, at least one cathode and an anode disposed in said plasma chamber, said at least one cathode and said anode being separated by a gap, said gap being adjustable, a power source coupled to said anode and said at least one cathode for providing a voltage across said anode and said at least one cathode, a plasma gas inlet for introducing a plasma gas from a plasma gas source into said plasma chamber at a plasma gas flow rate, and a sensor for monitoring conditions within said plasma chamber; and
b) a second chamber in fluid communication with said plasma chamber through an exit port, wherein said second chamber is maintained at a second pressure that is less than a first pressure in said plasma chamber, and wherein said substantially controllable plasma flows from said plasma chamber into said second chamber through said exit port.

2. The apparatus according to claim 1, wherein the plasma source is an expanding thermal plasma source.

3. The apparatus of claim 1, wherein said plasma gas inlet further includes means for controlling a flow of said plasma gas into said plasma chamber.

4. The apparatus of claim 1, wherein said means for controlling said flow includes at least one mass flow controller.

5. The apparatus according to claim 1, wherein said apparatus comprises a first plasma source and a second plasma source, wherein said first pressure of said plasma gas in said plasma chamber in said first plasma source and said first pressure of said plasma gas in said plasma chamber in said second plasma source are adjustable with respect to each other.

6. The apparatus according to claim 1, wherein said sensor is a pressure sensor, said pressure sensor being in fluid communication with said plasma chamber.

7. The apparatus according to claim 6, wherein said pressure sensor comprises a transducer.

8. The apparatus according to claim 1, wherein said sensor is one of a current sensor and a voltage sensor disposed in an electrical circuit between said power source and said cathode.

9. The apparatus according to claim 1, wherein said power source is a DC power source.

10. The apparatus according to claim 9, wherein said power source provides up to 100 amps of current at up to about 50 volts.

11. The apparatus according to claim 1, wherein said exit port comprises an orifice formed in said anode.

12. The apparatus according to claim 1, wherein said exit port comprises a floating cascade plate.

13. The apparatus according to claim 1, wherein said exit port comprises a floating wall of one of said plasma chamber and said second chamber.

14. The apparatus according to claim 1, wherein said apparatus is an apparatus for plasma treating a surface of an article with said substantially controllable plasma, wherein said article is disposed in said second chamber such that said substantially controllable plasma generated by said at least one plasma source exits said plasma chamber through said exit and impinges upon said surface.

15. The apparatus according to claim 14, further including at least one reactant gas injector disposed in said second chamber proximate to said exit port of each of said at least one plasma source, wherein said reactant gas injector directs a reactant gas into said substantially controllable plasma, and wherein said reactant gas reacts with said substantially controllable plasma to form a coating on said surface of said article.

16. The apparatus according to claim 1, wherein said apparatus comprises a first plasma source and a second plasma source, wherein said voltage across said cathode and said anode in said first plasma source and said voltage across said cathode and said anode in said second plasma source are adjustable with respect to each other.

17. A plasma source for generating a substantially controllable plasma, said plasma source comprising:
a) a plasma chamber in which said substantially controllable plasma is generated;
b) an anode disposed at a first end of said plasma chamber, said first end having an exit port through which said substantially controllable plasma exits said plasma chamber;
c) at least one adjustable cathode disposed in said plasma chamber, wherein said at least one adjustable cathode is movable to establish a gap between said anode and said at least one adjustable cathode;
d) a power source coupled to said anode and said at least one adjustable cathode for providing a voltage across said anode and said at least one adjustable cathode;
e) a plasma gas inlet for introducing a plasma gas from a plasma gas source into said plasma chamber at a plasma gas flow rate; and
f) at least one sensor for detecting and monitoring conditions within said plasma chamber.

18. The plasma source according to claim 17, further comprising a pressure adjustment means for moving said at least one adjustable cathode, said pressure adjustment means being coupled to said adjustable cathode.

19. The plasma source according to claim 18, wherein said pressure adjustment means is a pressure plate.

20. The plasma source according to claim 18, wherein said pressure adjustment means is a pneumatic drive.

21. The plasma source according to claim 17, further comprising a screw feed for moving said at least one adjustable cathode, said screw feed being coupled to said adjustable cathode.

22. The plasma source according to claim 17, wherein said at least one adjustable cathode comprises a wire.

23. The plasma source according to claim 22, further comprising a wire feed for moving said at least one adjustable cathode, said wire feed being coupled to said adjustable cathode.

24. The plasma source according to claim 17, wherein said at least one sensor includes a pressure sensor, said pressure sensor being in fluid communication with said plasma chamber.

25. The plasma source according to claim 24, wherein said pressure sensor comprises a transducer.

26. The plasma source according to claim 17, wherein said at least one sensor includes one of a current sensor and a voltage sensor disposed in an electrical circuit between said power source and said cathode.

27. The plasma source according to claim 17, wherein said power source is a DC power source.

28. The plasma source according to claim 27, wherein said power source provides up to 100 amps of current at 50 volts.

29. The plasma source according to claim 17, wherein said plasma gas inlet further includes means for controlling a flow of said plasma gas into said plasma chamber.

30. The plasma source according to claim 29, wherein said means for controlling said flow comprises at least one mass flow controller.

31. The plasma source according to claim 17, further including a control system for moving said at least one adjustable cathode, wherein said control system is coupled to said at least one sensor, said power source, and said at least one adjustable cathode, wherein said controller receives an input on said conditions in said plasma chamber and moves said at least one adjustable cathode to establish a predetermined gap between said anode and said at least one adjustable cathode based upon said input.

32. The plasma source according to claim 17, wherein said voltage is adjustable.

33. An apparatus for generating a substantially controllable expanding thermal plasma, said apparatus comprising:
a) at least one expanding thermal plasma source, said at least one expanding thermal plasma source comprising: a plasma chamber in which said substantially controllable plasma is generated; an anode; at least one adjustable cathode disposed in said plasma chamber, wherein said at least one adjustable cathode is movable to establish a gap between said anode and said at least one adjustable cathode; a power source coupled to said anode and said at least one adjustable cathode for providing a voltage across said anode and said at least one adjustable cathode; a plasma gas inlet for introducing a plasma gas from a plasma gas source into said plasma chamber at a plasma gas flow rate; and at least one sensor for detecting and monitoring conditions within said plasma chamber; and
b) a second chamber in fluid communication with said plasma chamber through an exit port, wherein said second chamber is maintained at a second pressure that is less than a first pressure in said plasma chamber, and wherein said substantially controllable plasma flows from said plasma chamber into said second chamber through said exit port.

34. The apparatus according to claim 33, wherein said apparatus comprises a first plasma source and a second plasma source, wherein said first pressure of said plasma gas in said plasma chamber in said first plasma source and said first pressure of said plasma gas in said plasma chamber in said second plasma source are adjustable with respect to each other.

35. The apparatus of claim 33, wherein said plasma gas inlet further includes means for controlling a flow of said plasma gas into said at least one plasma chamber.

36. The apparatus of claim 33, wherein said means for controlling said flow comprises at least one mass flow controller.

37. The apparatus according to claim 33, further comprising a pressure means for moving said at least one adjustable cathode, said pressure means being coupled to said adjustable cathode.

38. The apparatus according to claim 37, wherein said pressure means is a pressure plate.

39. The apparatus according to claim 37, wherein said pressure means is a pneumatic drive.

40. The apparatus according to claim 33, further comprising a screw feed for moving said at least one adjustable cathode, said screw feed being coupled to said adjustable cathode.

41. The apparatus according to claim 33, wherein said at least one adjustable cathode comprises a wire.

42. The apparatus according to claim 41, further comprising a wire feed for moving said at least one adjustable cathode, said wire feed being coupled to said adjustable cathode.

43. The apparatus according to claim 33, wherein said at least one sensor includes a pressure sensor, said pressure sensor being in fluid communication with said plasma chamber.

44. The apparatus according to claim 43, wherein said pressure sensor comprises a transducer.

45. The apparatus according to claim 33, wherein said at least one sensor includes one of a current sensor and a voltage sensor disposed in an electrical circuit between said power source and said at least one adjustable cathode.

46. The apparatus according to claim 33, wherein said power source is a DC power source.

47. The apparatus according to claim 46, wherein said power source provides up to 100 amps of current at up to about 50 volts.

48. The apparatus according to claim 33, further including a control system for moving said at least one adjustable cathode, wherein said control system is coupled to said at least one sensor, said power source, and said at least one adjustable cathode, wherein said controller receives an input on said conditions in said plasma chamber and moves said at least one adjustable cathode to establish a predetermined gap between said anode and said at least one adjustable cathode based upon said input.

49. The apparatus according to claim 33, wherein said exit port comprises an orifice formed in said anode.

50. The apparatus according to claim 33, wherein said exit port comprises a floating cascade plate.

51. The apparatus according to claim 33, wherein said exit port comprises a floating wall of one of said plasma chamber and said second chamber.

52. The apparatus according to claim 33, wherein said first pressure is at least about 0.1 atmosphere.

53. The apparatus according to claim 52, wherein said first pressure is about 1 atmosphere.

54. The apparatus according to claim 33, wherein said second pressure is less than about 1 torr.

55. The apparatus according to claim 54, wherein said second pressure is less than about 100 millitorr.

56. The apparatus according to claim 33, wherein said apparatus is an apparatus for plasma treating a surface of an article with said substantially controllable plasma, wherein said article is disposed in said second chamber such that said substantially controllable plasma generated by said at least one expanding thermal plasma source exits said plasma chamber through said exit and impinges upon said surface.

57. The apparatus according to claim 56, further including at least one reactant gas injector disposed in said second chamber proximate to said exit port of each of said at least one expanding thermal plasma source, wherein said reactant gas injector directs a reactant gas into said substantially controllable plasma, and wherein said reactant gas reacts with said substantially controllable plasma to form a coating on said surface of said article.

58. The apparatus according to claim 33, wherein said apparatus comprises a first expanding thermal plasma source and a second expanding thermal plasma source, wherein said voltage across said cathode and said anode in said first expanding thermal plasma source and said voltage across said cathode and said anode in said second expanding thermal plasma source are adjustable with respect to each other.

59. A method for generating a substantially controllable plasma, the method comprising the steps of:
a) providing at least one plasma source, the at least one plasma source comprising: a plasma chamber; an anode; at least one adjustable cathode disposed in the plasma chamber; a power source coupled to the anode and the at least one adjustable cathode; a plasma gas inlet; and at least one sensor;
b) providing a plasma gas through the plasma gas inlet to the plasma chamber in each of the at least one plasma source;
c) generating a plasma in the plasma chamber;
d) monitoring at least one parameter within the plasma chamber; and
e) controlling the plasma, wherein the plasma is controlled by adjusting conditions within the plasma chamber, based upon the monitoring of the at least one parameter.

60. The method according to claim 59, wherein the step of providing at least one plasma source comprises providing at least one expanding thermal plasma source.

61. The method according to claim 59, wherein the step of controlling the plasma comprises moving at least one of the adjustable cathode and the anode to establish a gap between the anode and the at least one adjustable cathode.

62. The method according to claim 59, wherein the step of controlling the plasma comprises controlling a pressure of plasma gas within the plasma chamber.

63. The method according to claim 62, wherein the step of controlling the plasma comprises controlling a pressure of plasma gas within the plasma chamber comprises controlling a first pressure of plasma gas in a first plasma source and a second pressure of the plasma gas in a second plasma source.

64. The method according to claim 59, wherein the step of controlling the plasma comprises controlling a voltage across the at least one adjustable cathode and the anode.

65. The method according to claim 59, wherein the step of controlling a voltage across the at least one adjustable cathode and the anode comprises controlling a voltage across the at least one adjustable cathode and the anode in a first expanding thermal plasma source and controlling a voltage across the at least one adjustable cathode and the anode in a second expanding thermal plasma source.

66. A method for treating an article using a substantially controllable expanding thermal plasma, the method comprising the steps of:
a) providing at least one expanding thermal plasma source, wherein the at least one expanding thermal plasma source comprises: a plasma chamber; an anode; at least one adjustable cathode disposed in the plasma chamber; a power source coupled to the anode and the at least one adjustable cathode; a plasma gas inlet; and at least one sensor;
b) providing a plasma gas through the plasma gas inlet to the plasma chamber in each of the at least one expanding plasma source;
c) generating a plasma in the plasma chamber;
d) monitoring at least one parameter within the plasma chamber; and
e) controlling the plasma, wherein the plasma is controlled by adjusting conditions within the plasma chamber, based upon the monitoring of the at least one parameter;
f) forming an expanding thermal plasma by expanding the plasma through an exit port into a second chamber in fluid communication with the plasma chamber, wherein the second chamber contains the article and is maintained at a second pressure that is less than a first pressure in said plasma chamber; and
g) impinging the expanding thermal plasma on a surface of the article, thereby treating the article.

67. The method according to claim 66, wherein the step of controlling the plasma comprises moving at least one of the adjustable cathode and the anode to establish a gap between the anode and the at least one adjustable cathode.

68. The method according to claim 66, wherein the step of controlling the plasma comprises controlling a pressure of plasma gas within the plasma chamber.

69. The method according to claim 68, wherein the step of controlling the plasma comprises controlling a pressure of plasma gas within the plasma chamber comprises controlling a first pressure of plasma gas in a first plasma source and a second pressure of the plasma gas in a second plasma source.

70. The method according to claim 66, wherein the step of controlling the plasma comprises controlling a voltage across the at least one adjustable cathode and the anode.

71. The method according to claim 70, wherein the step of controlling a voltage across the at least one adjustable cathode and the anode comprises controlling a voltage across the at least one adjustable cathode and the anode in a first expanding thermal plasma source and controlling a voltage across the at least one adjustable cathode and the anode in a second expanding thermal plasma source.

72. The method according to claim 66, the step of impinging the expanding thermal plasma on a surface of the article comprises:
a) injecting at least one reactant gas into the expanding thermal plasma; and
b) depositing a coating on the surface of the article.

73. An article having at least one coating disposed on a surface of the article, wherein the at least one coating is substantially uniform and has a selected property that exhibits a variation of less than about 10% across the surface of said article, the coating being deposited on the surface by:
a) providing at least one expanding thermal plasma source, wherein the at least one expanding thermal plasma source comprises: a plasma chamber; an anode; at least one adjustable cathode disposed in the plasma chamber; a power source coupled to the anode and the at least one adjustable cathode; a plasma gas inlet; and at least one sensor;
b) providing a plasma gas through the plasma gas inlet to the plasma chamber in each of the at least one expanding plasma source;
c) generating a plasma in the plasma chamber;
d) monitoring at least one parameter within the plasma chamber; and
e) controlling the plasma, wherein the plasma is controlled by adjusting conditions within the plasma chamber, based upon the monitoring of the at least one parameter;
f) forming an expanding thermal plasma by expanding the plasma through an exit port into a second chamber in fluid communication with the plasma chamber, wherein the second chamber contains the article and is maintained at a second pressure that is less than a first pressure in said plasma chamber;
g) injecting at least one reactant gas into the expanding thermal plasma; and
h) depositing a coating on the surface of the article.

74. The article according to claim 73, wherein the at least one coating comprises one of an abrasion-resistant coating, an ultraviolet filtering coating, an infrared reflective coating, an oxygen-barrier coating, moisture-barrier coating, an anti-reflective coating, a conductive coating, an adhesion layer, and combinations thereof.

75. The article according to claim 73, wherein the selected property of the at least one coating is one of coating thickness, abrasion resistance, ultraviolet radiation absorbance, infrared radiation reflectivity, modulus, hardness, oxygen permeability, water permeability, adhesion, surface energy, thermal conductivity, and electrical conductivity.
